(19) United States
(12) Patent Application Publication
(10) Pub. No.: US 2021/0331929 A1
(43) Pub. Date: Oct. 28, 2021

(54) DEVICE AND METHOD FOR PRODUCING HIGH-PURITY INDUSTRIAL SILICON

(71) Applicant: NORTH MINZU UNIVERSITY, Yinchuan City (CN)

(72) Inventors: Zhilin SHENG, Yinchuan City (CN); Xuetao LUO, Yinchuan City (CN); Liuqing HUANG, Yinchuan City (CN); Jinfu MA, Yinchuan City (CN); Wang SHENG, Yinchuan City (CN); Hui LU, Yinchuan City (CN); Chunping HOU, Yinchuan City (CN); Zhanlin CHEN, Yinchuan City (CN)

(73) Assignee: NORTH MINZU UNIVERSITY, Yinchuan City (CN)

(21) Appl. No.: 17/156,161

(22) Filed: Jan. 22, 2021

(30) Foreign Application Priority Data
Apr. 23, 2020 (CN) 202010326597.4

(51) Int. Cl. C01B 33/021

(52) U.S. Cl. CPC C01B 33/021

(57) ABSTRACT

A device and a method for producing a high-purity industrial silicon, wherein the device is a refining ladle provided with a steel plate layer, a heat insulation layer, a heat preservation layer, a protective layer and a working layer from outside to inside. The refining ladle is provided with two conical oxygen inlet channels and two conical argon inlet channels at the bottom. The method comprises: preparing a molten silicon with temperature≥2200° C.; pouring the molten silicon into a refining ladle after introducing oxygen and argon thereto and keeping the gas pressure at 1 standard atmospheric pressure, and keeping the molten silicon at 1700-1900° C.; adding a slag-forming agent thereto, and introducing oxygen and argon from the refining ladle bottom, obtaining a slag molten silicon; cooling the slag molten silicon to ambient temperature, solidifying and separating, obtaining a high-purity industrial silicon.

### CROSS REFERENCE TO RELATED APPLICATION

This application claims the priority of Chinese Patent Application No. 202010326597.4, entitled “Device and method for producing high-purity industrial silicon” filed with the China National Intellectual Property Administration on Apr. 23, 2020, which is incorporated herein by reference in its entirety.

### TECHNICAL FIELD

The present disclosure belongs to the field of industrial silicon smelting, and particularly relates to a device and a method for producing a high-purity industrial silicon.

### BACKGROUND

In accordance with the purity and industrial use, silicon materials are divided into the following three categories: industrial silicon (99% purity), solar-grade silicon (99.9999%-99.99999% purity) and electronic grade silicon (99.999999999%-99.9999999999% purity). Among them, the industrial silicon is one of the most important materials in information, new energy and new materials industries, and it has been derived into many kinds of industrial products, involving a wide range of fields. The industrial silicon is mainly used in the following four aspects: firstly, as an additive for smelting aluminum and steel; secondly, for synthesizing various organic silicon materials; thirdly, for preparing solar-grade polysilicon after purification; fourthly, for manufacturing new materials such as semiconductor and silicon carbide. The industrial chain starting from industrial silicon is not only huge in number and related industries, but also long in the chain, high in level, and high in technical content, being one of the leading directions of China's economic restructuring (Zhang Lifeng and Li Yaqiong, A method for refining solar-grade polysilicon [M]. Beijing: Metallurgical Industry Press, 2017:7-11).

Currently, industrial silicon is commonly produced by smelting silicon ore with a submerged arc furnace at home and abroad. Since impurities in the raw material and the furnace refractory material will enter the silicon melt during the high-temperature reaction, the industrial silicon produced contains a large amount of metal impurities such as Fe, Al, Ca and non-metal impurities such as C, O, B, P, resulting in a relatively low purity, only 98-99.5%, which severely affects its quality. Therefore, it is necessary to further refine the industrial silicon to remove the impurities therein, which would increase cost and energy consumption.

### SUMMARY

In view of the defects present in the existing devices for producing industrial silicon, the present disclosure is to provide a new device for producing a high-purity industrial silicon.

The present disclosure provides the following technical solution:

A device for producing a high-purity industrial silicon, being a refining ladle, provided with a steel plate layer, a heat insulation layer, a heat preservation layer, a protective layer and a working layer from outside to inside, wherein materials of the heat insulation layer, the heat preservation layer and the protective layer are asbestos boards, light clay bricks and high-alumina bricks, respectively, and materials of the working layer comprise magnesia-carbon bricks and aluminum-magnesia-carbon bricks. The refining ladle is provided with two conical oxygen inlet channels and two conical argon inlet channels that are symmetrical and oblique to the center at the bottom, wherein the oxygen inlet channels and argon inlet channels are at an oblique angle of 45° relative to the bottom of the refining ladle, each inlet channel has a small cone with a radius of 0.1 R₁ (R₁ is the radius of the bottom of the refining ladle), and is plugged with a conical micropore plug made of refractory materials, wherein each conical micropore plug has a taper of 15°, and the small taper end of each inlet channel is 0.5 R₁ away from the center of the bottom of the refining ladle. The steel plate at the top of the refining ladle is provided with four centrally symmetrical outlet channels with a radius of 0.1 R₂ (R₂ is the radius of the steel plate at the top of the refining ladle), and each outlet channel is 0.5 R₂ away from the center of the steel plate at the top of the refining ladle.

The present disclosure also provides a method for producing a high-purity industrial silicon, comprising the following steps:

1) preparing a molten silicon in a submerged arc furnace, with the proviso that the resulting molten silicon has a temperature not lower than 2200° C.;

2) slowly pouring the molten silicon with a temperature not lower than 2200° C. into a refining ladle after introducing oxygen and argon into the refining ladle and keeping the gas pressure therein at 1 standard atmospheric pressure, and keeping the molten silicon in the refining ladle at a temperature of 1700-1900° C.;

3) adding a slag-forming agent into the molten silicon in the refining ladle, and introducing oxygen and argon into the refining ladle from its bottom and keeping the gas pressure in the refining ladle at 1-1.2 standard atmospheric pressure, to obtain a slag molten silicon; and

4) naturally cooling the slag molten silicon obtained in step 3) to ambient temperature, solidifying and separating to obtain a high-purity industrial silicon.

In some embodiments, in step 3), the slag-forming agent is CaCO₃—SiO₂—CaCl₂ slag agent, and specifically comprises 45 wt. % of CaCO₃, 45 wt. % of SiO₂, and balanced CaCl₂.

In some embodiments, in step 3), the mass ratio of the slag-forming agent to the molten silicon is in a range of 0.5-1.

In some embodiments, in step 3), the process is carried out under the gas pressure of 1-1.2 standard atmospheric pressure.

In some embodiments, in step 3), the oxygen and argon are introduced after adding the slag-forming agent into the molten silicon for 15 minutes.

In some embodiments, in step 3), the oxygen and argon are introduced through the micropore plugs in the oxygen inlet channels and the micropore plugs in the argon inlet channels at the bottom of the refining ladle respectively, wherein the micropore plugs are made of a refractory material.

In some embodiments, in step 3), the oxygen and argon are introduced for 2-3 h.

In some embodiments, in step 3), the oxygen and argon are introduced at a rate of 7-9 L/min.

In some embodiments, the high-purity industrial silicon has a purity not lower than 99.99%.

Compared to the prior art, the present disclosure has the following significant effects:

The device of the present disclosure is a refining ladle, which is made of high-quality refractory and heat preservation materials, and has an increased volume and thickness, making it possible to improve the heat preservation property, and ensure that the smelting process does not occur wearing of the ladle and leaking, and the industrial silicon produced has a high purity. The method according to the present disclosure is able to effectively utilize a large amount of waste heat of the molten silicon after melting, and to combine a slagging purification technology, an oxygen-introducing refining technology and an argon-introducing refining technology, thereby enabling the impurities in silicon to be removed by a high-temperature separation method, which further improves the purity of the silicon; moreover, the whole process does not require introducing additional energy, thereby reducing the energy consumption, and achieving the purpose of saving cost. A high-purity industrial silicon can be obtained by reasonably controlling factors such as separation temperature, atmosphere, ventilation capacity, ventilation time, vent hole position distribution, slag-forming agent selection and slag-silicon ratio.

### BRIEF DESCRIPTION OF THE DRAWINGS

FIG. 1 is a structural schematic diagram of the device according to embodiment(s) of the present disclosure.

FIG. 2 shows a top view of the structure as shown in FIG. 1.

In the drawings: 1 represents a steel plate layer; 2 represents asbestos board(s); 3 represents an argon inlet channel; 4 represents light heat preservation brick(s); 5 represents high-alumina brick(s); 6 represents an oxygen inlet channel; 7 represents magnesia-carbon brick(s); 8 represents aluminum-magnesia-carbon brick(s); 9 represents an outlet channel

### DETAILED DESCRIPTION OF THE PREFERRED EMBODIMENT

Specific embodiments of the device according to the present disclosure will be described with reference to the accompanying drawings.

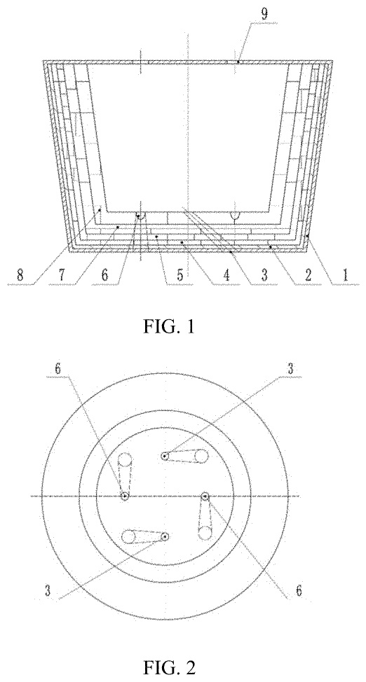

As shown in FIGS. 1 and 2, a device for producing a high-purity industrial silicon, being a refining ladle, provided with a steel plate layer 1, a heat insulation layer, a heat preservation layer, a protective layer and a working layer from outside to inside, wherein the materials of the heat insulation layer, the heat preservation layer and the protective layer are asbestos boards 2, light heat preservation bricks 4 and high-alumina bricks 5, respectively, and the materials of the working layer comprise magnesia-carbon bricks 7 and aluminum-magnesia-carbon bricks 8. The refining ladle is provided with two conical oxygen inlet channels 6 and two conical argon inlet channels 3 that are symmetrical and oblique to the center at the bottom, wherein the oxygen inlet channels 6 and argon inlet channels 3 are at an oblique angle of 45° relative to the bottom of the refining ladle, each inlet channel has a small cone with a radius of 0.1 R₁ (R₁ is the radius of the bottom of the refining ladle), and is plugged with a conical micropore plug made of refractory materials, wherein each conical micropore plug has a taper of 15°, and the small taper end of each inlet channel is 0.5 R₁ away from the center of the bottom of the refining ladle. The steel plate at the top of the refining ladle is provided with four centrally symmetrical outlet channels 9 with a radius of 0.1 R₂ (R₂ is the radius of the steel plate at the top of the refining ladle), and each outlet channel is 0.5 R₂ away from the center of the steel plate at the top of the refining ladle.

The specific embodiments of the production method according to the present disclosure will be further described by the following examples.

### Example 1

1) After introducing oxygen and argon into a refining ladle, and keeping the gas pressure therein at 1 standard atmospheric pressure, 200 kg of a molten silicon with a temperature higher than 2200° C. prepared in a submerged arc furnace was slowly poured into the refining ladle, and the molten silicon in the refining ladle was kept at a temperature of 1800° C.;

2) 100 kg of a slag-forming agent was added into the molten silicon in the refining ladle, and the resulting solution was kept at a temperature of 1800° C., wherein the slag-forming agent consisted of 45 wt. % of CaCO₃, 45 wt. % of SiO₂, and balanced CaCl₂;

3) oxygen and argon were each introduced into the refining ladle at a rate of 7 L/min for 2 h through pipes respectively connected with the conical micropore plugs plugged in the oxygen inlet channels and conical micropore plugs plugged in the argon inlet channels at the bottom, and the gas pressure in the refining ladle was kept at 1 standard atmospheric pressure, to obtain a slag molten silicon; and

4) the slag molten silicon obtained in step 3) was cooled to ambient temperature, and subjected to a slag-silicon separation, to obtain a silicon ingot, namely high-purity industrial silicon.

The mass concentration of the elements in the silicon ingot were measured by the inductively coupled plasma atomic emission spectrometry (ICP-AES), and the result was as follows: Si≥99.99%, Fe≤0.003%, Al≤0.001%, Ca≤0.003%, Ti≤0.0001%, Mn≤0.0001%, Mg≤0.0002%, Cu≤0.0003%, Na≤0.0001%, Zn≤0.0003%, As≤0.0002%, Pb≤0.0003%, Zr≤0.0004%, Ni≤0.0002%, V≤0.0001%, Cr≤0.0001%, C≤0.0004%, P≤0.0001%, B≤0.0001%, and S≤0.0001%.

### Example 2

After introducing oxygen and argon into a refining ladle, and keeping the gas pressure therein at 1 standard atmospheric pressure, 200 kg of a molten silicon with a temperature higher than 2200° C. prepared in a submerged arc furnace was slowly poured into the refining ladle, and kept at a temperature of 1800° C.; 100 kg of a slag-forming agent was added into the molten silicon in the refining ladle, and the resulting solution was kept at a temperature of 2000° C., wherein the slag-forming agent consisted of 45 wt. % of CaCO₃, 45 wt. % of SiO₂, and balanced CaCl₂; oxygen and argon were each introduced into the refining ladle at a rate of 8 L/min for 2.5 h through pipes respectively connected with the conical micropore plugs plugged in the oxygen inlet channels and conical micropore plugs plugged in the argon inlet channels at the bottom, and the gas pressure in the refining ladle was kept at 1.1 standard atmospheric pressure, to obtain a slag molten silicon; the slag molten silicon was cooled to ambient temperature, and subjected to a slag-silicon separation, to obtain a silicon ingot, namely high-purity industrial silicon.

The mass concentration of the elements in the silicon ingot were measured by the inductively coupled plasma atomic emission spectrometry (ICP-AES), and the result was as follows: Si≥99.99%, Fe≤0.003%, Al≤0.001%, Ca≤0.003%, Ti≤0.0001%, Mn≤0.0001%, Mg≤0.0002%, Cu≤0.0003%, Na≤0.0001%, Zn≤0.0003%, As≤0.0002%, Pb≤0.0003%, Zr≤0.0004%, Ni≤0.0002%, V≤0.0001%, Cr≤0.0001%, C≤0.0004%, P≤0.0001%, B≤0.0001%, and S≤0.0001%.

### Example 3

After introducing oxygen and argon into a refining ladle, and keeping the gas pressure therein at 1 standard atmospheric pressure, 200 kg of a molten silicon with a temperature higher than 2200° C. prepared in a submerged arc furnace was slowly poured into the refining ladle, and kept at a temperature of 1800° C.; 100 kg of a slag-forming agent was added into the molten silicon in the refining ladle, and the resulting solution was kept at a temperature of 1800° C., wherein the slag-forming agent consisted of 45 wt. % of CaCO₃, 45 wt. % of SiO₂, and balanced CaCl₂; oxygen and argon were each introduced into the refining ladle at a rate of 9 L/min for 3 h through pipes respectively connected with the conical micropore plugs plugged in the oxygen inlet channels and conical micropore plugs plugged in the argon inlet channels at the bottom, and the gas pressure in the refining ladle was kept at 1.2 standard atmospheric pressure, to obtain a slag molten silicon; the slag molten silicon was cooled to ambient temperature, and subjected to a slag-silicon separation, to obtain a silicon ingot, namely high-purity industrial silicon.

The mass concentration of the elements in the silicon ingot were measured by the inductively coupled plasma atomic emission spectrometry (ICP-AES), the result was as follows: Si≥99.99%, Fe≤0.003%, Al≤0.001%, Ca≤0.003%, Ti≤0.0001%, Mn≤0.0001%, Mg≤0.0002%, Cu≤0.0003%, Na≤0.0001%, Zn≤0.0003%, As≤0.0002%, Pb≤0.0003%, Zr≤0.0004%, Ni≤0.0002%, V≤0.0001%, Cr≤0.0001%, C≤0.0004%, P≤0.0001%, B≤0.0001%, and S≤0.0001%.

### Example 4

After introducing oxygen and argon into a refining ladle, and keeping the gas pressure therein at 1 standard atmospheric pressure, 200 kg of a molten silicon with a temperature higher than 2200° C. prepared in a submerged arc furnace was slowly poured into the refining ladle, and kept at a temperature of 1800° C.; 150 kg of a slag-forming agent was added into the molten silicon in the refining ladle, and the resulting solution was kept at a temperature of 2000° C., wherein the slag-forming agent consisted of 45 wt. % of CaCO₃, 45 wt. % of SiO₂, and balanced CaCl₂; oxygen and argon were each introduced into the refining ladle at a rate of 8 L/min for 2.5 h through pipes respectively connected with the conical micropore plugs plugged in the oxygen inlet channels and conical micropore plugs plugged in the argon inlet channels at the bottom, and the gas pressure in the refining ladle was kept at 1.1 standard atmospheric pressure, to obtain a slag molten silicon; the slag molten silicon was cooled to ambient temperature, and subjected to a slag-silicon separation, to obtain a silicon ingot, namely high-purity industrial silicon.

The mass concentration of the elements in the silicon ingot were measured by the inductively coupled plasma atomic emission spectrometry (ICP-AES), and the result was as follows: Si≥99.99%, Fe≤0.003%, Al≤0.001%, Ca≤0.003%, Ti≤0.0001%, Mn≤0.0001%, Mg≤0.0002%, Cu≤0.0003%, Na≤0.0001%, Zn≤0.0003%, As≤0.0002%, Pb≤0.0003%, Zr≤0.0004%, Ni≤0.0002%, V≤0.0001%, Cr≤0.0001%, C≤0.0004%, P≤0.0001%, B≤0.0001%, and S≤0.0001%.

### Example 5

After introducing oxygen and argon into a refining ladle, and keeping the gas pressure therein at 1 standard atmospheric pressure, 200 kg of a molten silicon with a temperature higher than 2200° C. prepared in a submerged arc furnace was slowly poured into the refining ladle, and kept at a temperature of 1800° C.; 200 kg of a slag-forming agent was added into the molten silicon in the refining ladle, and the resulting solution was kept at a temperature of 2000° C., wherein the slag-forming agent consisted of 45 wt. % of CaCO₃, 45 wt. % of SiO₂, and balanced CaCl₂; oxygen and argon were each introduced into the refining ladle at a rate of 8 L/min for 2.5 h through pipes respectively connected with the conical micropore plugs plugged in the oxygen inlet channels and conical micropore plugs plugged in the argon inlet channels at the bottom, and the gas pressure in the refining ladle was kept at 1.1 standard atmospheric pressure, to obtain a slag molten silicon; the slag molten silicon was cooled to ambient temperature, and subjected to a slag-silicon separation, to obtain a silicon ingot, namely high-purity industrial silicon.

The mass concentration of the elements in the silicon ingot were measured by the inductively coupled plasma atomic emission spectrometry (ICP-AES), and the result was as follows: Si≥99.99%, Fe≤0.003%, Al≤0.001%, Ca≤0.003%, Ti≤0.0001%, Mn≤0.0001%, Mg≤0.0002%, Cu≤0.0003%, Na≤0.0001%, Zn≤0.0003%, As≤0.0002%, Pb≤0.0003%, Zr≤0.0004%, Ni≤0.0002%, V≤0.0001%, Cr≤0.0001%, C≤0.0004%, P≤0.0001%, B≤0.0001%, and S≤0.0001%.

What is claimed is:

1. A device for producing high-purity industrial silicon, being a refining ladle, provided with a steel plate layer, a heat insulation layer, a heat preservation layer, a protective layer and a working layer from outside to inside, wherein the materials of the heat insulation layer, the heat preservation layer and the protective layer are asbestos boards, light clay bricks and high-alumina bricks, respectively, and the materials of the working layer comprise magnesia-carbon bricks and aluminum-magnesia-carbon bricks, and wherein the refining ladle is provided with two conical oxygen inlet channels and two conical argon inlet channels that are symmetrical and oblique to the center at the bottom.

2. The device as claimed in claim 1, wherein the oxygen inlet channels and argon inlet channels are at an oblique angle of 45° relative to the bottom of the refining ladle, and each inlet channel has a small cone with a radius of 0.1 R₁, wherein R₁ is the radius of the bottom of the refining ladle.

3. The device as claimed in claim 2, wherein each oxygen inlet channel and argon inlet channel is plugged with a conical micropore plug made of refractory materials, wherein each conical micropore plug has a taper of 15°, and the small taper end of each inlet channel is 0.5 R₁ away from the center of the bottom of the refining ladle.

4. The device as claimed in claim 1, wherein the steel plate at the top of the refining ladle is provided with four centrally symmetrical outlet channels with a radius of 0.1 R₂, wherein R₂ is the radius of the steel plate at the top of the refining ladle, and each outlet channel is 0.5 R₂ away from the center of the steel plate at the top of the refining ladle.

5. A method for producing a high-purity industrial silicon, wherein the method is carried out with the device as claimed in claim 1, and comprises the following steps:
1) preparing a molten silicon in a submerged arc furnace, with the proviso that the resulting molten silicon has a temperature not lower than 2200° C.;
2) slowly pouring the molten silicon with a temperature not lower than 2200° C. into a refining ladle after introducing oxygen and argon into the refining ladle and keeping the gas pressure therein at 1 standard atmospheric pressure, and keeping the molten silicon in the refining ladle at a temperature of 1700-1900° C.;
3) adding a slag-forming agent into the molten silicon in the refining ladle, introducing oxygen and argon into the refining ladle from its bottom and keeping the gas pressure in the refining ladle at 1-1.2 standard atmospheric pressure, to obtain a slag molten silicon; and
4) naturally cooling the slag molten silicon obtained in step 3) to ambient temperature, solidifying and separating to obtain a high-purity industrial silicon.

6. The method as claimed in claim 5, wherein in step 3), the slag-forming agent is CaCO₃—SiO₂—CaCl₂ slag agent.

7. The method as claimed in claim 5, wherein in step 3), the mass ratio of the slag-forming agent to the molten silicon is in a range of 0.5-1.

8. The method as claimed in claim 5, wherein in step 3), introducing oxygen and argon and keeping the gas pressure in the refining ladle at 1.2 standard atmospheric pressure are carried out after adding the slag-forming agent into the molten silicon for 10-15 min.

9. The method as claimed in claim 5, wherein the oxygen and argon are introduced through the micropore plugs plugged in the oxygen inlet channels and the micropore plugs plugged in the argon inlet channels at the bottom of the refining ladle.
